(19) United States
(12) Patent Application Publication
(10) Pub. No.: US 2009/0321650 A1
(43) Pub. Date: Dec. 31, 2009

(54) Radiation Security Blanket

(76) Inventors: Steven P. Kadner, Albuquerque, NM (US); Markku J. Koskelo, Albuquerque, NM (US); Robert Craig Yoder, Crown Point, IN (US)

Correspondence Address: CARSTENS & CAHOON, LLP, P O BOX 802334, DALLAS, TX, 75380, US

(21) Appl. No.: 12/107,675

(22) Filed: Apr. 22, 2008

(51) Int. Cl. G01T 1/16; G01T 1/24; G01T 3/00

(52) U.S. Cl. 250/362; 250/361 R; 250/370.05; 250/371; 250/391; 250/392; 250/390.03; 250/370.07

(57) ABSTRACT

A radiation detection blanket for use in surveying a broad or irregular area of interest for radiation emissions. Small radiation detectors are affixed to the fabric and distributed relative to its surface area. The detector materials may be of the OSL, TLD, or ERD variety, or may be a combination of OSL, TLD and ERD. Detector materials having varying thicknesses of high Z coatings may be clustered together in the blanket fabric to yield a gamma radiation spectrum. Use of a converter material on the detector material allows the blanket to detect neutron radiation. The blanket includes specialized transmission means for allowing the detector materials to be read individually, by passing the reader along a surface or along an edge of the blanket. A composite radiation measurement is obtained upon reading the individual detectors, allowing determination of the radiation distribution within the object being surveyed by the blanket.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

The present invention relates to radiation detection devices.

2. Description of Related Art Including Information Disclosed Under 37 CFR 1.97 and 1.98

At present, there is a legitimate concern that radioactive materials can be used by terrorists as a weapon of mass destruction, or of mass disruption. Such radioactive material could include large quantities of medical isotopes, commercial radioactive sources used for thickness gauges, well logging, etc, spent nuclear fuel, or special nuclear material (SNM). SNM can be used to build nuclear weapons, while the other types of materials are possible components of a radioactive dispersal device (RDD).

The national regulatory bodies for radioactive material control, such as the US NRC, are generally charged with overseeing the various commercial entities that use radioactive materials in some form or another. However, the level of such oversight and its effectiveness varies from country to country. In the countries who have signed the international nuclear non-proliferation treaty, the International Atomic Energy Agency (IAEA), which is part of the United Nations, provides an additional oversight function. SNM is generally kept under even closer watch by the appropriate authorities in each country. Even with all this oversight, hundreds of sources, some of them highly active, are lost every year.

Nuclear facilities that store SNM are potential targets of theft by the terrorists. The same holds true for spent nuclear fuel or radioactive waste sites. Hospitals, nuclear power plants and any industrial facility that uses radioactive materials as part of its operation are also potential targets.

To address the security concern of an RDD or a nuclear weapon being smuggled to a country and used as a weapon, the US and many other countries have embarked on various programs to detect, identify and interdict any illicit transportation of radioactive materials of any kind.

The nuclear facilities that have SNM have traditionally been monitored under the International Safeguards regime. Under this regime, all material movement is monitored with sophisticated radiation detection and video surveillance technology. Typically this has involved the use of sensitive portal monitors at all exit and entrance points. Nuclear power plants that have large quantities of nuclear and radioactive materials have long employed similar methods.

With the threat of radiological terrorism, many of these technologies are being adapted for wider use. For example, the US Customs and Border Patrol, which is now under the Department of Homeland Security (DHS), have deployed radiation portal monitors to scan people and vehicles at border crossings. The key objective of this effort is to detect illicit radiological and/or nuclear material without slowing down legitimate commerce. FIG. 1 depicts such a pedestrian radiation portal while FIG. 2 depicts such a vehicle radiation portal.

The first generation of portal monitors used in this fashion used plastic scintillation detector based systems. Such systems are generally capable of detecting the presence or absence of excess radiation within seconds or fractions of a second in the object of interest. This allows them to be used in pass through mode, much like road tolls, as long as the traffic is slowed down to a reasonable speed. However, these devices have proven to be susceptible to a very large number of nuisance alarms.

These devices must be sensitive enough to defeat attempts to hide illicit radioactive material. This sensitivity has the side effect of detecting not only the illicit material, but also naturally occurring radioactivity (i.e., background radiation, or NORM). While the nuisance alarms are most often caused by the presence of NORM, they are also triggered by the presence of people who have had medical procedures involving radiotracers, or of transportation of legitimate industrial isotopes.

To address this need to separate the nuisance alarms from real alarms, the use of these first generation portal monitors must be supplemented with hand-held identifiers. When a portal monitor alarms, the security personnel assigned to the location must use a small portable spectroscopic radiation measuring instrument that is able to both detect and identify the type of radioactivity that caused the alarm. While this procedure works, there are some practical problems associated with it. FIG. 3 depicts such a prior art handheld radiation detection device in use.

To be portable, the hand-held identifier has to have a much smaller detector than is generally used in the large portal monitors. This requires bringing the portable detector very close to the radioactive material to obtain a strong enough signal to identify the radioisotope.

For many vehicles, such as large long distance trucks with cargo, it is impractical to use the hand-held identifier to cover the entire rig. There is also the question of whether such hand-held devices are used in a consistent fashion to identify the contents of every bit of potential threat cargo. Investigation of frequent nuisance alarms results in the expenditure of substantial man-hours and an unacceptable impediment to legitimate commerce.

First generation portals also lack the ability to identify the type of radioactive materials being monitored. To address these perceived weaknesses, particularly their lack of specificity, the DHS has embarked on a program to develop Advanced Spectroscopy Portals. These portals are able to not only detect, but also identify the type of radioactive material present. FIG. 4 depicts such a prior art radiation detection portal.

The experience from the deployments of the first generation portal monitors, as well as the early indications from the Advanced Spectroscopy Portals, is that it is a struggle to perform the detection and identification even with the most sophisticated detector technologies. This is true because the object of interest is in the field of view of the detectors for only a fraction of a second. There are two possible ways to improve on this. One is to increase the time that the object is being measured with these Advanced Spectroscopy Portals. The other is to somehow make the detectors much larger to increase the radiation detection efficiency. Unfortunately, there are practical limitations to how much of either approach can be used with the present design configurations. It is contrary to the mandate of not slowing down legitimate commerce to make each object, such as a vehicle, stop to be sensed. At the same time, the present state of the art in detector manufacturing technologies does not permit making larger individual detector elements. The only option is to use more detector elements, which is cost prohibitive.

Various detector types are used in dosimetry devices to record the radiation exposure to individuals or locations. These dosimeters typically record the dose due to the presence of gamma radiation, but there are materials that can also be used to record other types of radiation. Some dosimeters are combinations of multiple radiation detection methods. A thermoluminescent dosimeter (TLD) is one of the most commonly used types of dosimeters to record the dose. It will reveal the dosage with the use of a specialized reader after the user has sent the device to be read.

Electronic dosimeters use various detector types to record and report on the dose and the dose rate real time. Many of them have built-in alarm capabilities which trigger if the dose or the dose rate exceeds a preset value. It has been suggested that either TLDs or more likely electronic dosimeters would be deployed in large quantities to be worn by personnel employed at radiation check points. By virtue of at least one of the detectors of such dosimeters having a good probability of being close to a radiation source, it can be calculated that a network of such detectors could also provide a powerful detection capability. The additional benefit is that dosimeters are cheap in comparison to portal monitors, and could therefore be deployed in very large quantities. The drawback is that the number of such detectors near each and every object that needs to be measured is low and the dosimeters have very small detectors with limited surface area. Therefore, this is not a very efficient means for detection. Furthermore, the dosimetry detectors are not radioisotope specific. They can essentially detect only the presence or absence of any radiation and would therefore be subject to the same nuisance alarms as the first generation portal monitors.

Accordingly, a need exists for a radioactive materials detecting means that can identify the radioisotope in question. Further, a need exists for a detecting means that is sensitive enough to rapidly and accurately detect radioactive materials with minimal spurious alarms. Further, a need exists for a detecting means that can be read quickly in the field. Further, a need exists for a detecting means that is economical to manufacture and use.

It is an object of this invention to overcome the known problems of typical portal monitor applications for cargo containers and other objects of interest as described above with the use of a network, or mat or tarpaulin-type of a large surface area detector made of many small detectors connected to each other and to a readout device.

### BRIEF SUMMARY OF THE INVENTION

The present invention provides a fabric with radiation detection materials dispersed along its surface area. The radiation detection materials may be equally spaced across the fabric surface or may be concentrated in specific areas depending on structural or monitoring needs. The fabric may be entirely flexible, rigid, or semi-rigid.

The radiation detection materials may be of the TLD, optically stimulated luminescence (OSL), or electronically readable semiconductor based radiation detection (ERD) variety, or may include some combination thereof. Each detector is affixed to the fabric by weaving the materials into the fabric; encasing the materials between layers of the fabric; embedding the materials in the fabric; or by otherwise adhering the materials to the fabric.

Detector materials having varying thicknesses of high Z coatings may also be utilized. The use of the coatings in varying thicknesses allows the materials to discriminate between different gamma radiation signatures of the objects being measured. This affords the ability to distinguish between the medical, industrial, natural and special types of nuclear materials. Neutron radiation may also be detected by use of detector materials coated with a single converter material, or with differing converter materials to achieve a neutron spectrum.

To read the widely-spaced detector materials, a suitable transmission means is provided. If the detector materials are of the OSL variety, a light transmission means is provided. For example, perforations in the fabric surface, a transparent fabric surface, or light pipes may be utilized. Likewise, TLD variety materials require a transmission means that allows light to travel from the TLD to a reader. The ERD variety materials require a conductive transmission means to allow an electrical current to travel to and from the material being read.

### BRIEF DESCRIPTION OF THE SEVERAL VIEWS OF THE DRAWING(S)

The present invention will be more fully understood by reference to the following detailed description of the preferred embodiments of the present invention when read in conjunction with the accompanying drawings, in which like reference numbers refer to like parts throughout the views, wherein:

FIG. 1 is an image of a prior art pedestrian radiation detection portal;

FIG. 2 is an image of a prior art vehicle radiation detection portal;

FIG. 3 is a depiction of an individual using a prior art handheld radiation detection device to inspect a piece of equipment;

FIG. 4 depicts the prior art Advanced Spectroscopy Portals as developed by DHS;

FIG. 5 depicts a cluster of OSL detectors configured to provide radiation spectrum determination as used in an embodiment of the present invention;

FIG. 6 is a single OSL detector configured to detect neutron radiation as used in an embodiment of the present invention;

FIG. 7 is a first embodiment of the present invention depicting multiple detectors affixed to a mat or tarpaulin format;

FIG. 8 is a side view of the previous embodiment depicting the means by which the detectors may be read;

FIG. 9 is a second embodiment of the present invention depicting multiple detectors affixed to a mat or tarpaulin format in which the means for reading each detector is accessible through an edge of the fabric;

FIG. 10 is side view of the previous embodiment depicting the means by which the reader communicates with the detector material; and

FIG. 11 is another side view of the previous embodiment depicting the means by which each detector may communicate with a reader.

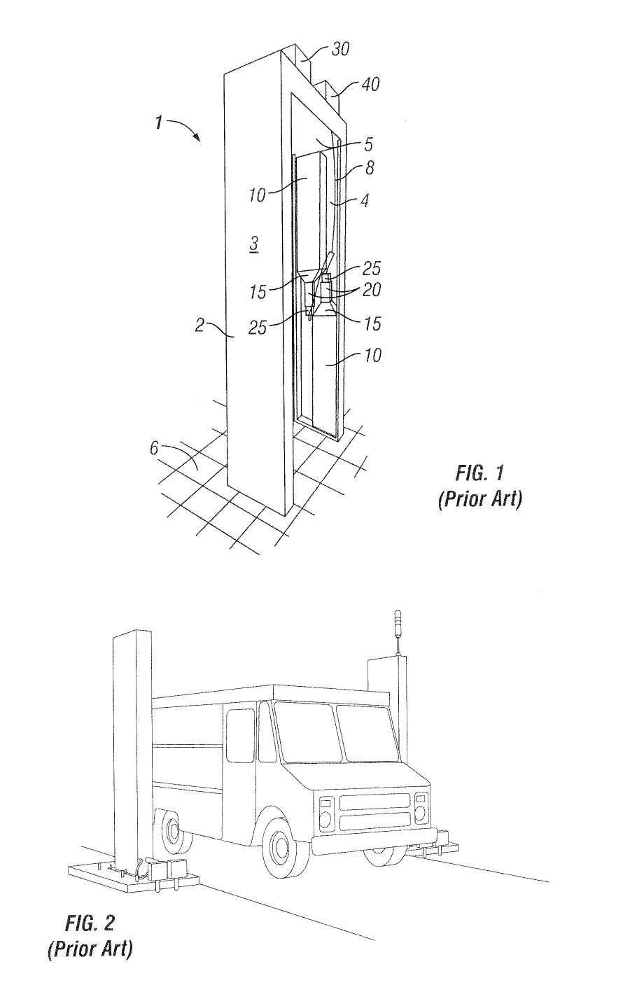

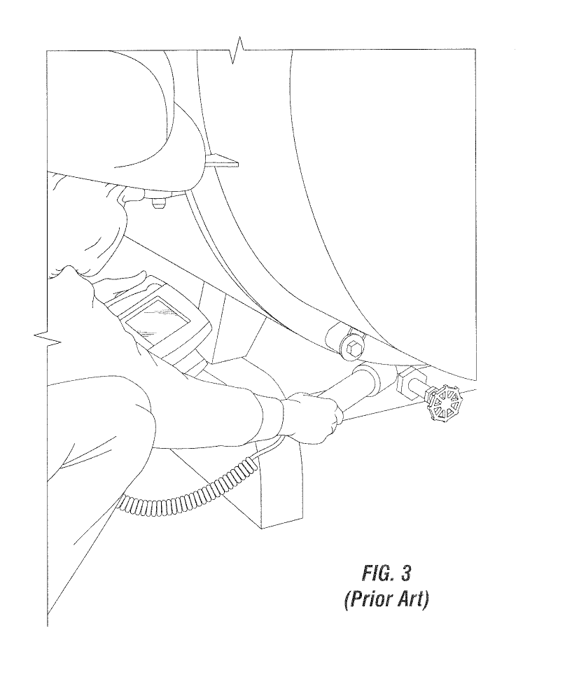

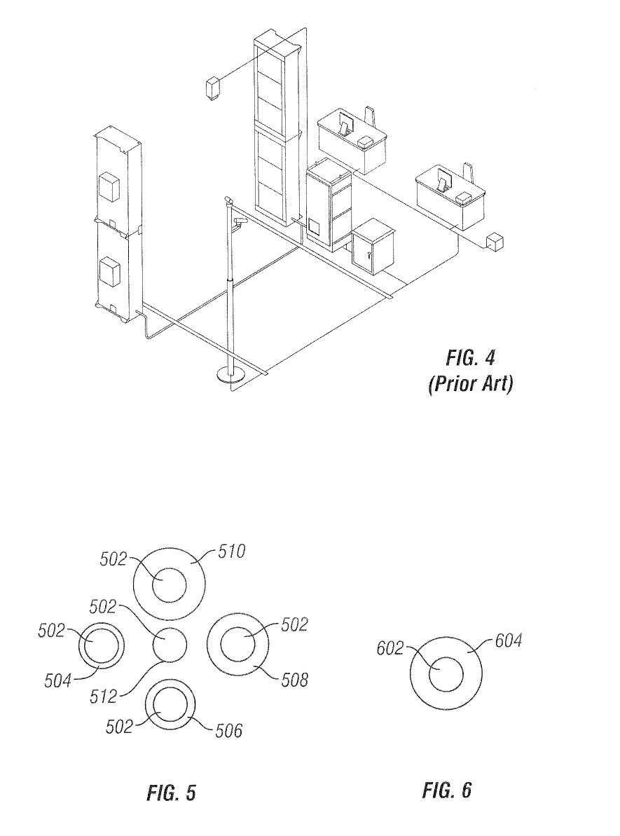

Where used in the various figures of the drawing, the same reference numbers designate the same or similar parts. Furthermore, the terms “top,” “bottom,” “first,” “second,” “upper,” “lower,” “height,” “width,” “length,” “end,” “side,” “horizontal,” “vertical,” and similar terms, if used herein, should be understood to refer only to the structure shown in the drawing and are utilized only to facilitate describing the invention.

All figures are drawn for ease of explanation of the basic teachings of the present invention only; the extensions of the figures with respect to number, position, relationship, and dimensions of the parts to form the preferred embodiment will be explained or will be within the skill of the art after the following teachings of the present invention have been read and understood. Further, the exact dimensions and dimensional proportions to conform to specific requirements will likewise be within the skill of the art after the following teachings of the present invention have been read and understood.

### DETAILED DESCRIPTION OF THE INVENTION

As used herein, the term “blanket” is intended to refer to all embodiments of the present invention into which the disclosed radiation detectors have been incorporated. This includes all mat, tarpaulin, paper, fabric, clothing, and other described forms. The term “fabric” is intended to refer to all materials suitable for constructing the blanket, such as cloth; paper; plastic; flexible metals; and the like.

In an embodiment of the present invention, the radiation security blanket invention utilizes optically stimulated luminescence (OSL) materials for detectors. U.S. Pat. No. 7,098,470 to Akselrod, et al., the disclosure of which is hereby incorporated, describes such materials. Available OSL detectors, such as those made from a base of aluminum oxide crystals (Al₂O₃) with varying impurities, allow for repeatable measurement of radiation exposure.

As the OSL crystal is exposed to ionizing or neutron radiation, the material stores energy proportional to the dose received. The dose can then be “read” by stimulating the crystal with a suitable wavelength light. When stimulated, the crystal gives off a light of a different wavelength with an intensity level that is directly proportional to the dose recorded (the exposure energy). Also, because the detectors are passive, no external power source is necessary. The only item that requires a power source is the reader.

If the OSL material is coated with different density materials, the detectors coated with high Z (high density) materials tend to record the dose associated only with high energy gamma rays. Utilizing detectors coated with successively varying densities of such material allows calculation of an approximate energy spectrum of the radiation that is present. FIG. 5 depicts such an embodiment.

In this embodiment, the detector material (502) is surrounded by an attenuating coating (504-510). The detector coatings vary from thin (504) to thick (510). This attenuating coating allows some determination regarding whether the material that the detectors record is of concern or not. For example, if a detector has a relatively thick (510) or high Z coating it will only respond to gammas of higher energy than one with a thin coating (504) or no coating at all (512). In another embodiment, each of the detectors has a different type of coating. Examples of materials having a high (but differing) Z includes: lead; tungsten; cadmium; tin; uranium; gold; platinum; etc. The type of material chosen may be dictated by considerations such as cost, safety, and material availability.

For example, a particular embodiment may utilize multiple OSL detectors, each having various thicknesses or types of attenuating coating (high Z materials). By reading and comparing the output from each of the exposed detectors, an approximate spectrum of the radiation to which the materials were exposed can be generated and analyzed. The OSL detectors with no coating could be distributed in a matrix, with each detector surrounded by other detectors with varying thicknesses and/or types of high Z coatings (such as in FIG. 5). By clustering the varying detector materials, more exposure data can be accumulated for a given point in the overall detector matrix.

An OSL detector can also be employed to detect neutron radiation. FIG. 6 depicts such an embodiment. Neutrons can be sensed by coating the detector (602) with converter material such as polyethylene or Lithium-6 (604). For neutrons, it may not be necessary to determine the energy of the neutrons by reading the detector material. What may ultimately be important in a survey is merely the presence (or absence) of excess neutrons. However, different coatings may be utilized if neutron energy discrimination is important, such as when seeking to obtain a neutron spectrum. For example, coating the OSL material with Lithium-6 allows increases the material's sensitivity to thermal/low energy neutrons. Conversely, a polyethylene coating increases the material's sensitivity to high-energy neutrons. By mixing OSL detectors having these two coatings, it is therefore possible to obtain a neutron spectrum.

In another embodiment, the invention utilizes TLD materials. This type of detector also stores energy related to gamma or neutron radiation exposure in its crystal lattice. The device is then read by heating the detector. When heated, the detector material emits a glow curve proportional to the recorded dose (the exposure energy). Such TLD materials are sensitive to gamma and neutron radiations and may be used to obtain a gross gamma or neutron dose.

In yet another embodiment, the invention utilizes ERD type detectors. These types of detectors record gamma radiation exposure within a semiconductor crystal. Such devices are then read by applying a fixed current and recording the resulting output voltage (which is a function of detector exposure—i.e., the exposure energy) while others may be read by applying a fixed voltage to the device and reading the output current (which is a function of detector exposure—i.e., the exposure energy).

An example of an ERD is a conventional MOSFET. When a properly-biased MOSFET device is irradiated, electron-hole pairs are generated within the silicon dioxide by the incident radiation. Electrons, whose mobility in SiO2 at room temperature is about 4 orders of magnitude greater than holes, quickly move out of the gate electrode while holes move in a stochastic fashion towards the Si/SiO2 interface. At this interface, the holes become trapped in long term sites, causing a negative threshold voltage shift (DVTH) which can persist for years. The difference in voltage shift before and after exposure can be measured, and is proportional to radiation dose.

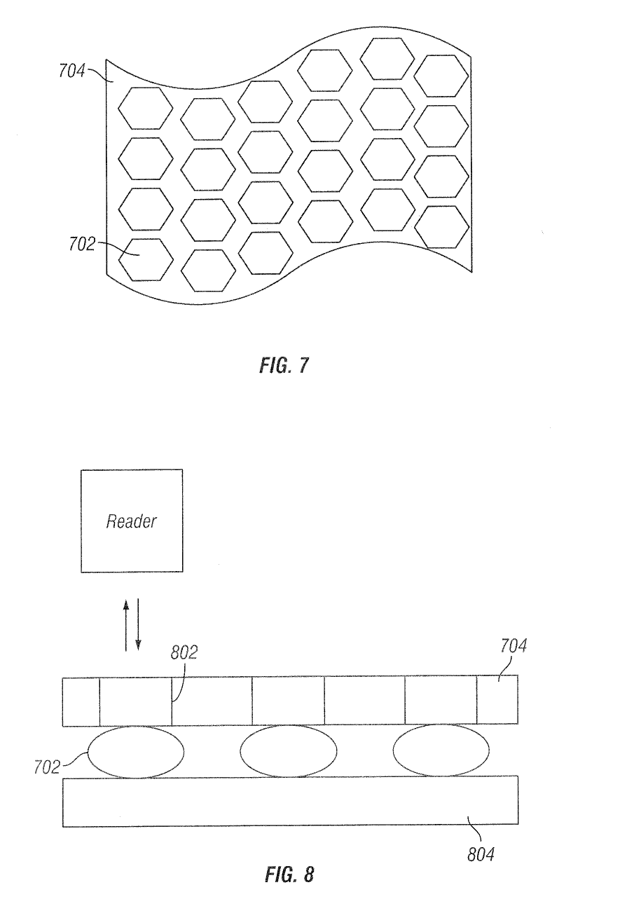

FIG. 7 depicts a first embodiment of the invention. In this embodiment, the radiation security blanket is comprised of detectors (702) (such as OSL, TLD, ERD, or the like) that are woven, sewn, or otherwise attached, into or onto, a mat or tarpaulin-type fabric format (704) with the detectors spaced across the material's surface. Typically, the detector materials will be evenly spaced across the blanket to allow consistent coverage. However, it is also possible to concentrate detector materials in specific locations. This allows a higher density of detectors to cover an area of higher sensitivity or importance.

If OSL materials are utilized, it is necessary to channel light to and from the detectors. This can be accomplished through means such as perforations in the blanket surface, light pipes incorporated in the blanket material, or transparent blanket materials. FIG. 8 is a side view of the embodiment depicting the means for a reader to access the detector material (702). The use of fiber optic cables for light pipes allows the blanket to remain flexible while still providing a transmission means for light to travel to and from the detector material.

In the embodiment of FIG. 8, the detector materials (702) reside between layers within the blanket (704 and 804). The blanket material encasing or sandwiching the detector material (702) affords the detector protection and support. Openings (802) in the blanket allow light to travel from a reader to the detector (702) to stimulate the detector material. The light emitted from the stimulated detector (702) (i.e., the exposure energy) may then pass back through the opening (802) to the reader where the light intensity is converted to an exposure reading.

The blanket can be read using a small handheld device that is moved across the blanket's surface. Alternatively, the blanket may be fed through a reader in an automated fashion by stretching the blanket across rollers. Readout devices positioned across the top of the surface of the blanket could then illuminate and read, simultaneously, the detectors passing beneath each.

The composite signal from the multiple readouts from a single readout device (manual operation) or from multiple readout devices (automatic operation) can be combined into a composite image of the radiation field to which the blanket has been exposed. This includes not only an approximation of the energy distribution of the gamma radiation, and the presence or absence of neutron radiation, but also positional information on where in the cargo the radioactive source is located. In addition, the gamma spectrum may be obtained from the readout in addition to a neutron spectrum. The gamma and neutron spectrum may then be combined to assist in characterizing the radiation source.

the opening (802) in the blanket may actually be closed to ambient air. For example, a transparent material (such as glass or plastic) may fill the opening to prevent entrance of environmental contaminants. This may prolong the life of the blanket (704) by preventing direct contact with the detectors (702). The transparent material would serve to channel light to and from the reader and detector (702).

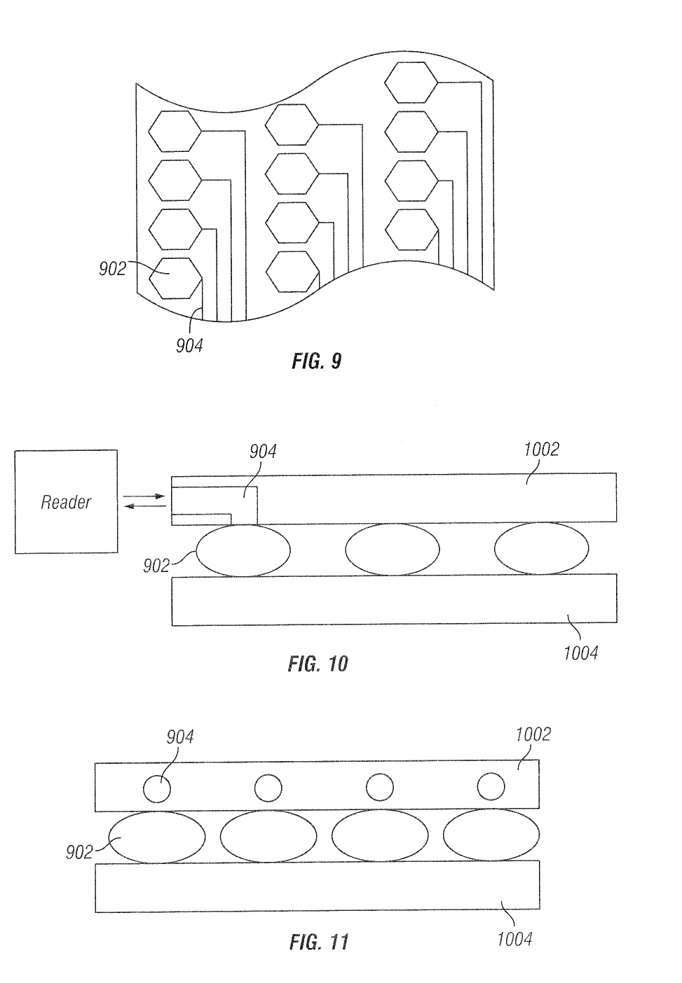

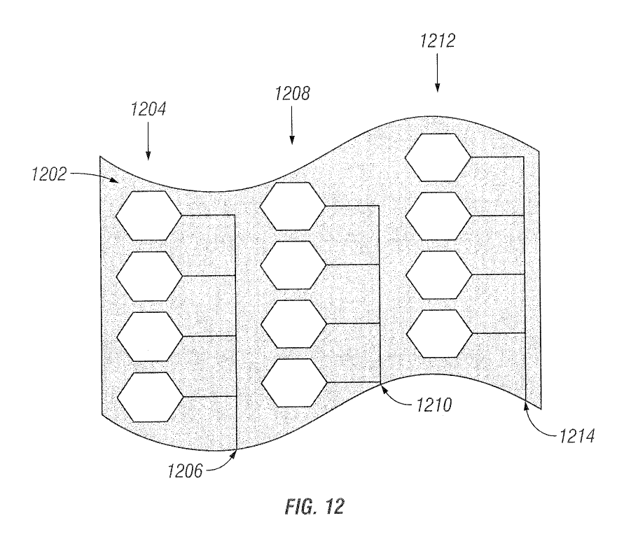

FIG. 9 depicts an embodiment of the present invention utilizing light pipes (904) (such as fiber optic elements) running from the edge of the blanket to the individual detectors (902). FIG. 10 and FIG. 11 are cutaway side images depicting the light pipes (904) and how they communicate with the detector materials (902). In this embodiment, the blanket surface (1002) can be any material which is essentially transparent to the radiation to be detected. Use of light pipes (904) allows both surfaces (1002 and 1004) to be opaque to visible light. This may allow the blanket to be disguised sufficiently such that its true purpose cannot be ascertained by visible inspection.

In this embodiment, the light pipes are directed to one edge (FIG. 11) of the blanket. To read the detectors, a reader may be passed along the edge such that it communicates with each individual light pipe in sequence. Conversely, the reader could be a stationary unit that accepts a corner of the reading edge and physically moves the edge along the reader's light emission/detection element.

The blanket may also utilize TLD detector devices in place of the OSL materials. In such an embodiment, the detectors must be heated sufficiently to measure the luminescence of the material and thus obtain the dose measurement. The light released from the TLD material (i.e., the exposure energy) can be read via the aforementioned light pipes or openings in the blanket face. Due to the high temperatures required, such detector material would necessitate blanket materials that can likewise resist temperature degradation or destruction.

The blanket may also utilize ERD in place of the OSL material. In such an embodiment, electrical wires connect the detector materials to a reader. Copper wire may be used in place of the light pipes described in the previous embodiments. These copper wires allow direct measurement of the exposed detector materials. The wires may pass from the ERD material to the fabric surface (as in FIGS. 7 and 8), or may pass to the edge of the blanket as in (FIGS. 9-12). Any type of wire may be utilized so long as it conducts electricity. Further, such wire may be single or multi-strand.

To further improve detector durability, the detector material layer can be sandwiched between multiple layers of the mat or tarpaulin fabric. So long as the material chosen for the body of the mat or tarpaulin is transparent to the radiation to be monitored, additional fabric layers should have little attenuation effect.

In another embodiment, the blanket may have one surface that is shielded to prevent the penetration of gamma or neutron radiation. The opposite surface would be transparent to gamma and/or neutron radiation. This would allow the blanket to discriminate between radiation emanating from surrounding cargo and from the cargo being surveyed. In this embodiment, the blanket would be more sensitive to the suspect cargo beneath its radiation transparent surface.

In another embodiment, the detector materials utilize a converter material for detecting neutron radiation (FIG. 6). The blanket material may feature only neutron detectors or some combination of ionizing and neutron detector materials. Further, the blanket may have ionizing radiation detectors with varying high Z coatings (as depicted in FIG. 5). This provides a blanket having the ability to detect an approximate gamma spectrum with determination of the presence or absence of neutron radiation. If detectors with varying converter materials are also present, an approximate neutron spectrum may also be obtained.

Detectors may also be grouped and read in zones. For example, one embodiment may feature different groupings of detectors with each grouping having a particular thickness of attenuating coating. FIG. 12 depicts such a blanket (1202) embodiment. In FIG. 12, a first grouping of detectors consists of materials with no attenuating coating (1204), a relatively thin attenuating coating (1208), and a relatively thick attenuating coating (1212). A single transmission means may be utilized to read each grouping of detectors (1206, 1210, and 1214, respectively). Such a means for reading the groupings would be more efficient. However, individual transmission means may also be used as depicted in FIGS. 7 through 11. As stated previously, the transmission means is material dependent (i.e., fiber optic for OSL and TLD, electrical wire for ERD).

The blanket in a tarpaulin form may be used by draping it over a container to be surveyed. After the tarp has remained in place for a sufficient amount of time, any activity emanating from the container will be recorded by the detectors. To improve the survey results, such tarps could also be left in place during transport and read immediately prior to offloading the cargo.

The blanket in mat form may be placed beneath the cargo or materials to be surveyed. In this embodiment, the mat may be placed on a pallet or platform beneath the item to be surveyed. After the mat has remained in place for a sufficient amount of time, any activity emanating from the item will be recorded. The mat can be placed beneath cargo and kept in place during transport or can be utilized temporarily such as when offloading cargo.

In yet another embodiment, the detectors can be integrated into a fabric that can serve as a wall or portable shelter covering. As a wall covering, the walls of a room (such as a customs inspection station) can be covered and utilized to passively monitor the radioactivity of items placed within the room. Similarly, portable shelter coverings can be assembled to store and monitor items for radioactivity. Handheld or automated readers can then be used to determine and record the detectors' dose.

In another embodiment, the OSL detector crystals can be integrated into a sheet of paper that can serve as a bill of lading or other identification document. This document can then be attached to the outer surface of the item being shipped or placed within the shipping container. During shipping, the detector paper will record any radioactivity emanating from the shipped item. Upon receipt of the item, the paper can be removed and scanned by a reader (in a fashion similar to an ordinary document scanner) to determine the total dose recorded.

In another embodiment, the detectors may be woven into materials such as textiles for clothing. For example, apparel may be worn by security personnel that feature embedded OSL or TLD detectors that will passively monitor radiation to which the wearer is exposed. The apparel may then be periodically read to record the total dose received by the personnel. Further, because multiple detectors are present, an analysis of the combination of the detectors read will provide a distribution map of the exposure. This allows accurate accounting of the exposure experienced by the various parts of the body. If the detectors are of the OSL variety, the apparel may be read while it is being worn. If the detectors are of the TLD variety, reading will require heating the internal crystal to measure its thermoluminescence.

The blanket embodiments depicted herein are generally comprised of flexible fabric materials. However, other materials may be utilized without straying from the inventive concept. For example, semi-rigid plastic may be used in order to improve the rigidity and overall structural integrity of the device. Further, materials may be combined. For example, a semi-rigid plastic may be utilized on one side of the blanket while the other side is flexible cloth or the like. Also, metals may be utilized in specific areas or for entire surfaces. For example, if a particular area of the blanket is subject to wear or requires greater protection from some external force, the specific area may utilize metal on one or both sides. One skilled in the art will appreciate that the materials chosen must be transparent to the radiation in question on at least one surface.

Such a radiation security blanket as described also features the added benefit of being a completely passive device. The dose and radiation energy information is detected and retained due to the physical characteristics of the material. Thus, beyond the excitation light (during reading), no external power source is required. Power is required only for the readout devices.

One embodiment of the present invention provides a mat format for large area radiation monitoring. Such a detector array can be placed under a cargo container for a brief period of time. This period will typically be minutes rather than seconds giving the device a much longer measurement time than is the case with portal monitors. Alternatively, the mat can remain under the container during transport for continuous monitoring.

Another embodiment of the present invention provides a paper format. In this format the blanket material is any type of material suitable for use as printable or writeable paper. Such a detector array can be attached to the outer surface of a shipping carton and record any radioactivity that may emanate from the item being shipped. At the receiving end, the detector paper may be removed and scanned on a device similar to a commercial document scanner to determine total exposure.

Another embodiment of the present invention provides a tarpaulin format. Such a detector array can envelop a cargo container from three sides, allowing a greater probability for detecting a radiation event. Also, by securing the cargo during transport with such a detector, a much longer count time is afforded.

Another embodiment of the present invention provides a fabric suitable as a wallpaper or portable shelter covering format. Such a detector array can be utilized in a temporary or permanent storage shelter to passively monitor for radioactivity emanating from items placed within.

Another embodiment this invention provides the basic detector network in a cloth type of a format with the radiation readout capabilities described above that can also be made into vests, blankets, and other clothing items to be worn by personnel intent on detecting radiation, or protecting themselves from radiation.

The invention may be embodied in other specific forms without departing from the spirit or essential characteristics thereof. The present embodiments are therefore to be considered in all respects as illustrative and not restrictive.

Further, the recitation of method steps does not denote a particular sequence for execution of the steps. Such method steps may therefore be performed in a sequence other than that recited unless the particular claim expressly states otherwise.

Accordingly, the scope of the invention is established by the appended claims rather than by the foregoing description. While various alterations and permutations of the invention are possible, the invention is to be limited only by the following claims and equivalents (58,266).

We claim:

1. A radiation detection blanket for use in surveying a broad or irregular area for nuclear radiation emissions, the blanket comprising:
a first material having at least one layer; and
a plurality of radiation detectors, wherein the detectors are affixed to the first material, and wherein the detectors may be individually stimulated by a detector reader by stimulation energy passing from the reader to a single detector, and wherein the reader may read the single detector by observing exposure energy passing from the single detector to the reader.

2. The blanket of claim 1 wherein the radiation detectors are chosen from the group consisting of OSL, TLD and ERD type detectors.

3. The blanket of claim 2 wherein at least one radiation detector comprises a high Z coating.

4. The blanket of claim 2 wherein at least one radiation detector comprises a converter material for neutron detection.

5. The blanket of claim 1 wherein at least one radiation detector is an OSL type comprising a high Z coating.

6. The blanket of claim 1 wherein at least two radiation detectors are OSL type and wherein at least one OSL detector comprises a high Z coating while at least one other OSL detector comprises a converter material.

7. The blanket of claim 1 wherein at least two radiation detectors are OSL type and wherein at least two of the OSL type detectors comprise high Z coatings of different thickness.

8. The blanket of claim 1 wherein at least one radiation detector is an OSL type comprising a converter material for neutron detection.

9. The blanket of claim 1 wherein at least two radiation detectors are OSL type and wherein at least two of the OSL type detectors comprise different converter materials for detecting different neutron energies.

10. The blanket of claim 1 wherein at least one detector is an OSL type and at least one detector is chosen from the group consisting of TLD and ERD type detectors.

11. The blanket of claim 10 wherein the first material comprises at least one electricity-conducting wire that allows the detector reader to detect the voltage within at least one ERD detector.

12. The blanket of claim 1 wherein the first material has at least one transparent surface.

13. The blanket of claim 1 wherein the first material comprises at least one light pipe that allows the detector reader to detect light emanating from at least one detector.

14. The blanket of claim 1 wherein at least one layer of the first material comprises at least one aperture that allows the detector reader to detect light emanating from at least one detector.

15. The blanket of claim 1 wherein the detectors are woven into the first material.

16. The blanket of claim 1 further comprising:
a second material, wherein the second material is oriented relative to the first material such that the detectors are interposed between the first and second materials.

17. The blanket of claim 16 wherein the first material is transparent to the radiation of interest and the second material is opaque to the radiation of interest.

18. A method for reading the blanket of claim 1 after having surveyed an object of interest, the method steps comprising:
(a) supporting the blanket;
(b) reading a plurality of the detectors via the transmission means utilizing a detector-specific reader device;
(c) obtaining a detector-specific radiation exposure value for each detector read; and
(d) generating a composite radiation measurement based upon the exposure values.

19. The method of claim 18, the method steps further comprising:
(a)(i) stretching the blanket over a rigid support apparatus; and
(a)(ii) moving the blanket relative to the reader device.

20. The method of claim 18 wherein the first material requires that at least one detector be read with the reader device positioned over one of the blanket surfaces, the method steps further comprising:
(a)(i) moving the reader device relative to the surface of the blanket.

21. The method of claim 18 wherein the first material requires that at least one detector be read with the reader device positioned along one edge of the blanket, the method steps further comprising:
(b)(i) moving the reader device relative to the edge of the blanket.

22. The method of claim 18, the method steps further comprising:
(d)(i) obtaining a gamma spectrum based upon the composite radiation measurement.

23. The method of claim 18, the method steps further comprising:
(d)(i) obtaining a gamma spectrum based upon the composite radiation measurement; and
(e) determining the approximate location of the radiation source within the object of interest.

24. The method of claim 18, the method steps further comprising:
(d)(i) obtaining a gamma spectrum based upon the composite radiation measurement;
(d)(ii) obtaining a neutron spectrum based upon the composite radiation measurement; and
(e) characterizing the radiation source within the object of interest.
